(19) United States
(12) Patent Application Publication
(10) Pub. No.: US 2025/0371873 A1
(43) Pub. Date: Dec. 4, 2025

(54) System of Extracting Image Features of Basketball Match Videos to Find a Wide-Open Pass Position and Providing an Offensive Passing Suggestion, and Method Thereof

(71) Applicants: SQ Technology ( Shanghai) Corporation, Shanghai (CN); Inventec Corporation, Taipei City (TW)

(72) Inventors: Chuan-Cheng Chiu, Taipei City (TW); Hai-Hong Sha, Shanghai (CN); Po-Shou Chiu, Taipei City (TW)

(21) Appl. No.: 18/825,847

(22) Filed: Sep. 5, 2024

(30) Foreign Application Priority Data
May 31, 2024 (CN) 202410706048.8

(51) Int. Cl. G06V 20/40; G06T 7/20; G06V 10/44

(52) U.S. Cl. CPC G06V 20/42; G06T 7/20; G06V 10/44; G06V 2201/07

(57) ABSTRACT

A system of finding a wide-open pass position to provide an offensive passing suggestion and a method thereof are disclosed. In the system, historical match videos are used to train a wide-open analysis model, the trained wide-open analysis model is used to determine wide-open positions in a target match video, and a passing direction of a ball-carry player in the target match video is determined; when it is determined that the passing direction does not match the wide-open position, a passing suggestion is generated to provide the players with opportunities to fully understand and apply tactics. Therefore, the effect of providing a teaching model that provides experience of the competition process and feedback can be achieved.

### CROSS-REFERENCE TO RELATED APPLICATION

This application claims the benefit of Chinese Application Serial No. 202410706048.8, filed May 31, 2024, which is hereby incorporated herein by reference in its entirety.

### BACKGROUND OF THE INVENTION

### 1. Field of the Invention

The present invention is related to a basketball passing suggestion system and a method thereof, and more particular to a system of extracting image features of basketball match videos to find a wide-open pass position and providing an offensive passing suggestion, and a method thereof.

### 2. Description of the Related Art

With the rapid development of digitization and technology, artificial intelligence (AI), Big Data, and virtual reality (VR) technologies have shown their unique value in many fields, especially in the field of teaching.

The existing forms of teaching include basic classroom teaching, assistive on-site teaching and individual guidance, special composite teaching, computerized multimedia teaching. However, most of the existing forms of teaching are only suitable for static teaching, but not suitable for dynamic teaching, such as teaching basketball or other sports.

The conventional basketball physical education teaching process includes theoretical learning and practical exercises. The basketball theory usually only guides players through experience teaching, but the basketball sport has high requirements for technical practice and tactical theory. The conventional teaching methods are faced with limitations of venues, resources, and personalized teaching, especially in terms of tactical understanding and practical application. Apart from actual competitions, it is difficult to provide players with sufficient practice opportunities, and that is, even in the match, the coach can only observe training results of players superficially. Therefore, there is a lack of a teaching mode to experience the tactical process and provide immediate feedback.

According to above-mentioned contents, what is needed is to develop an improved solution to solve the problem that it is difficult to provide a player with an opportunity to fully understand and apply tactics except in actual match.

### SUMMARY OF THE INVENTION

An objective of the present invention is to disclose a system of finding a wide-open pass position to provide an offensive passing suggestion and a method thereof, to solve the problem that it is difficult to provide a player with an opportunity to fully understand and apply tactics except in actual match.

To achieve the objective, the present invention provides a system of finding a wide-open pass position to provide an offensive passing suggestion, and the system includes a memory and a processor. the memory configured to store at least one computer instruction. The processor is connected to the memory and configured to execute the at least one computer instruction to generate a data obtaining module, an image analyzing module, an image processing module, a model training module, a wide-open identification module, and a suggestion generating module. The data obtaining module is configured to read a wide-open rule, and load historical match videos, wherein each of the historical match videos includes a basketball and players, and the players includes at least one offensive player and at least one defensive player. The image analyzing module is configured to analyze the historical match videos to extract historical image features of each of the historical match videos at different time points, and analyze a target match video to extract target image features of each of the target match videos at different time points and to identify and to track field positions of a basketball and the players in the target match video based on the target image features. The image process module is configured to determine whether a ball-carry player passes the basketball to another player based on the field positions of the basketball and the players, and then extract a target match screen of the target match video in which the basketball is passed, and determine a passing direction of the basketball. The model training module is configured to use a machine learning algorithm to train a wide-open analysis model based on the historical image features representing distances and relative positions between the players satisfying the wide-open rule. The wide-open identification module is configured to use the wide-open analysis model to analyze at least one wide-open pass position in the target match screen. The suggestion generating module is configured to generate a passing suggestion when the passing direction does not match the wide-open pass position.

To achieve the objective, the present invention provides a method of finding a wide-open pass position to provide an offensive passing suggestion, the method includes steps of: loading historical match videos, wherein each of the historical match videos comprises a basketball and players, and the players comprises at least one offensive player and at least one defensive player; reading a wide-open rule; analyzing the historical match videos to extract historical image features of each of the historical match videos at different time points; using a machine learning algorithm to train a wide-open analysis model based on the historical image features which represent distances and relative positions between the players satisfying the wide-open rule; loading a target match video, wherein the target match video comprises at least one of the players; analyzing the target match video to extract target image features of the target match video at different time points, and to identify and track field positions of the basketball and the players in the target match video; when it is determined that a ball-carry player among the players passes the basketball to another player among the players based on the field positions of the basketball and the players, extracting a target match screen of the target match video in which the basketball is passed, and determining a passing direction of the basketball; using the wide-open analysis model to analyze at least one wide-open pass position (also referred to herein as a “wide-open postion”) in the target match screen; when it is determined that the passing direction does not match the at least one wide-open pass position, generating a passing suggestion.

According to the system and the method of the present invention, the difference between the present invention and the conventional technology is that the historical match videos are used to train the wide-open analysis model, the trained wide-open analysis model is used to determine the wide-open positions in the target match video, and the passing direction of the ball-carry player in the target match video is determined; when the passing direction does not match the wide-open position, the passing suggestion is generated, so that the conventional problem can be solved and the effect of providing a teaching model that provides experience of the competition process and feedback can be achieved.

### BRIEF DESCRIPTION OF THE DRAWINGS

The structure, operating principle and effects of the present invention will be described in detail by way of various embodiments which are illustrated in the accompanying drawings.

FIG. 1 is a schematic view of a device of finding a wide-open pass position to provide an offensive passing suggestion, according to the present invention.

FIG. 2 is a schematic view of a system of finding a wide-open pass position to provide an offensive passing suggestion, according to the present invention.

FIG. 3A is a flowchart of a method of finding a wide-open pass position to provide an offensive passing suggestion, according to the present invention.

FIG. 3B is a flowchart of a method of training a wide-open analysis model, according to the present invention.

FIG. 3C is a flowchart of a method of displaying a target match video, a passing suggestion and marking a wide-open position, according to the present invention.

FIG. 3D is a flowchart of a method of generating a passing suggestion based on an offensive tactic, according to the present invention.

FIG. 3E is a flowchart of a method of training an action prediction model to predict a future wide-open position, according to the present invention.

FIG. 4 is a schematic view of displaying a target match video and a tactical board to mark a wide-open position, according to an embodiment of the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims.

These embodiments are provided so that this disclosure is thorough and complete, and fully conveys the inventive concept to those skilled in the art. Regarding the drawings, the relative proportions, and ratios of elements in the drawings may be exaggerated or diminished in size for the sake of clarity and convenience. Such arbitrary proportions are only illustrative and not limiting in any way. The same reference numbers are used in the drawings and description to refer to the same or like parts. As used herein, the singular forms “a”, “an” and “the” are intended to include the plural forms as well, unless the context clearly indicates otherwise. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the words “comprise” and “include,” and variations such as “comprises,” “comprising,” “includes,” or “including,” will be acknowledged to imply the inclusion of stated elements but not the exclusion of any other elements.

The present invention provides a technical solution to analyze a wide-open position in a match screen of a basketball match and generate a passing suggestion for a ball-carry player based on the wide-open position.

The device mentioned in the present invention can be implemented by a computing apparatus. The computing apparatus mentioned in the present invention can include, but not limited to, one or more processing modules, one or more memory modules, and a bus connected to different hardware components including the memory module and the processing module. Through the multiple hardware components, the computing apparatus can load and execute the operating system, so that the operating system runs on the computing apparatus and executes software or programs. In addition, the computing apparatus can include an outer shell, and the above-mentioned hardware components are disposed in the outer shell.

The bus mentioned in the present invention can include at least one type of bus, for example, the bus can include at least one of a data bus, an address bus, a control bus, an expansion bus, and a local bus. The bus of a computation device can include, but not limited to, a parallel bus such as an industry standard architecture (ISA) bus, a peripheral component interconnect (PCI) bus, a video electronics standards association (VESA) local bus, or a serial bus such as a USB, or a PCI express (PCI-E/PCIe) bus.

The processing module of the computing apparatus is coupled with the bus. The processing module includes a register group or a register space. The register group or the register space can be completely set on the processing chip of the processing module, or can be all or partially set outside the processing chip and is coupled to the processing chip through dedicated electrical connection and/or a bus. The processing module can be a central processing unit, a microprocessor, or any suitable processing component. If the computing apparatus is a multi-processor apparatus, that is, the computing apparatus includes processing modules, and the processing modules can be all the same or similar, and coupled and communicated with each other through a bus. The processing module can interpret a computer instruction or a series of multiple computer instructions to perform specific operations or operations, such as mathematical operations, logical operations, data comparison, data copy/moving, so as to drive other hardware component, execute the operating system, or execute various programs and/or module in the computing apparatus. The computer instructions can include assembly language instructions, instruction set architecture instructions, machine instructions, machine-related instructions, microinstructions, firmware instructions, or source code or object code written in one or more programming languages. The instructions can be executed entirely on a single computing apparatus, partially on a single computing apparatus, or partially on one computing apparatus and partially on another interconnected computing apparatus. The above-mentioned programming language can be, for example, object-oriented languages such as Common Lisp, Python, C++, Objective-C, Smalltalk, Delphi, Java, Swift, C#, Perl, Ruby, as well as procedural languages like C or similar languages.

The computing apparatus usually also includes one or more chipsets. The processing module of the computing apparatus can be coupled to the chipset, or electrically connected to the chipset through the bus. The chipset includes one or more integrated circuits (IC) including a memory controller and a peripheral input/output (I/O) controller, that is, the memory controller and the peripheral input/output controller can be implemented by one integrated circuit, or implemented by two or more integrated circuits. Chipsets usually provide I/O and memory management functions, and multiple general-purpose and/or dedicated-purpose registers, timers. The above-mentioned general-purpose and/or dedicated-purpose registers and timers can be coupled to or electrically connected to one or more processing modules to the chipset for being accessed or used. In an embodiment, the chipset can be a part of the processing module.

The processing module of the computing apparatus can also access the data stored in the memory module and mass storage area installed on the computing apparatus through the memory controller. The above-mentioned memory modules include any type of volatile memory and/or non-volatile memory (NVRAM), such as Static Random Access Memory (SRAM), Dynamic Random Access Memory (DRAM), Read-Only Memory (ROM), or Flash memory. The above-mentioned mass storage area can include any type of storage device or storage medium, such as hard disk drives, optical discs, flash drives, memory cards, and solid state disks (SSD), or any other storage device. In other words, the memory controller can access data stored in static random access memory, dynamic random access memory, flash memory, hard disk drives, and solid state drives.

The processing module of the computing apparatus can also be in connection and communication with peripheral devices and interfaces including peripheral output devices, peripheral input devices, communication interfaces, or data/signal receivers through the peripheral I/O controller and the peripheral I/O bus. The peripheral input device can be any type of input device, such as a keyboard, mouse, trackball, touchpad, or joystick. The peripheral output device can be any type of output device, such as a display, or a printer; the peripheral input device and the peripheral output device can also be the same device such as a touch screen. The communication interface can include a wireless communication interface and/or a wired communication interface. The wireless communication interface can include the interface capable of supporting wireless local area networks (such as Wi-Fi, Zigbee, etc.), Bluetooth, infrared, and near-field communication (NFC), 3G/4G/5G and other mobile communication network (cellular network) or other wireless data transmission protocol; the wired communication interface can be an Ethernet device, a DSL modem, a cable modem, an asynchronous transfer mode (ATM) devices, or optical fiber communication interfaces and/or components. The data/signal receiver can include a GPS receiver or physiological signal receiver. The physiological signals received by the physiological signal receiver include, but are not limited to, heartbeat, blood oxygen levels, and so on. The processing module can periodically poll various peripheral devices and interfaces, so that the computing apparatus can input and output data through various peripheral devices and interfaces, and can also communicate with another computing apparatus having the above-mentioned hardware components.

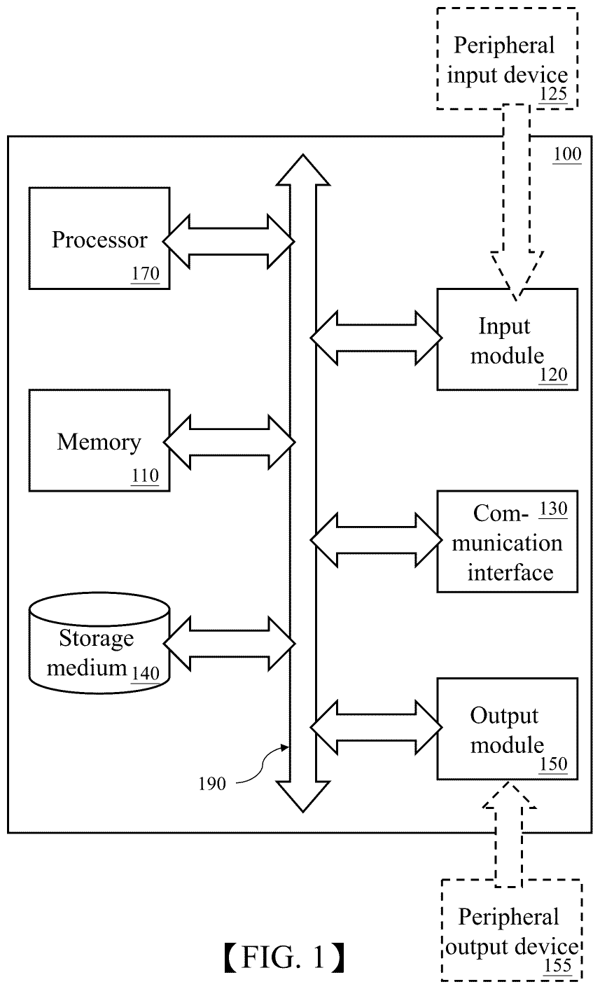

Please refer to FIG. 1, which shows a device of finding a wide-open pass position to provide an offensive passing suggestion, according to the present invention. As shown in FIG. 1, a device 100 includes a memory 110, an input module 120, a communication interface 130, a storage medium 140, an output module 150, a processor 170, and a bus 190. The memory 110, the input module 120, the communication interface 130, the storage medium 140, the output module 150, the processor 170 are connected to each other through the bus 190.

The memory 110 is configured to store at least set of computer instructions.

The input module 120 is configured to provide input data through a peripheral input device 125 of the device 100. For example, through the peripheral input device 125 (such as a keyboard or a mouse), the input module 120 is configured to input a wide-open rule, select or input a storage path of match videos including historical match videos and a target match video and/or headshots of players, input player profiles (such as limb parameters or ID). The limb parameters include, but not limited to, a height, an arm length, a leg length, a pace distance of a player.

The communication interface 130 is connected to a network device (not shown in the drawings) such as an external network storage device or a server. The communication interface 130 is configured to request the connected network device and download data therefrom. For example, the communication interface 130 can be connected to the network device to download data such as a wide-open rule or a match video. In an embodiment, the network device transmits the match video to the device 100 through the form of file or streaming, but the present invention is not limited to above-mentioned examples.

The storage medium 140 is configured to store the data received through the communication interface 130 and also store the data required by the processor 170 (that is, the data is provided to the processor 170), for example, the data can be a wide-open rule, or a match video. The storage medium 140 can also stores the data generated by the processor 170, such as wide-open information or a passing suggestion.

The output module 150 is configured to output the data generated by the processor 170 through the peripheral output device 155 of the device 100. For example, the output module 150 can output the match video, the wide-open position, the passing suggestion outputted from the peripheral output device 155, through peripheral device (such as a displayer or a touch screen), so that the device 100 can display the match video, mark the wide-open position, and display the passing suggestion.

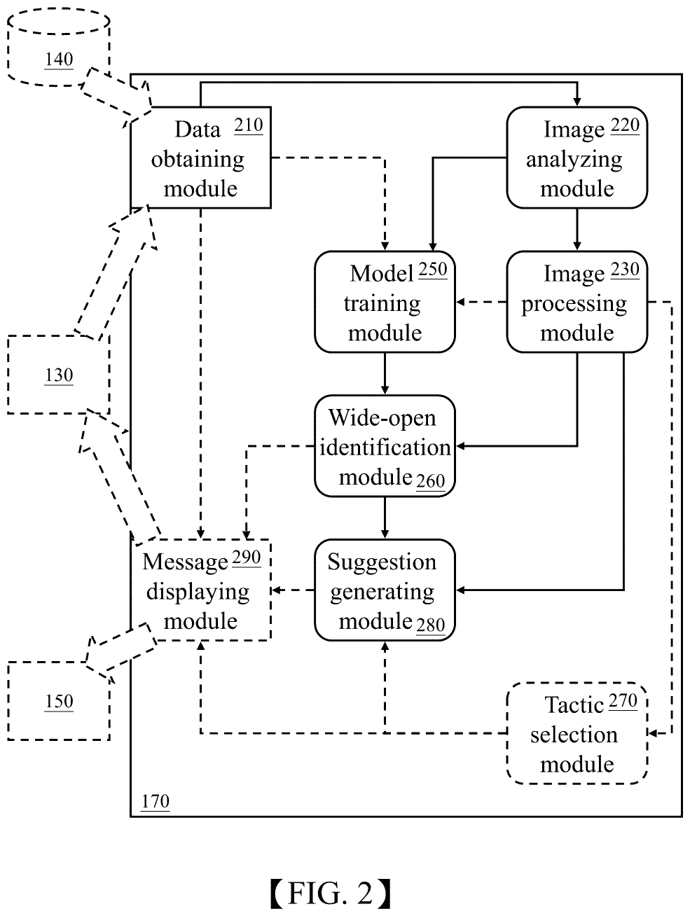

Please refer to FIG. 2, which is a schematic view of a system of finding a wide-open pass position to provide an offensive passing suggestion, according to the present invention. As shown in FIG. 2, the processor 170 includes a data obtaining module 210, an image analyzing module 220, an image processing module 230, a model training module 250, a wide-open identification module 260 and a suggestion generating module 280, and the processor 170 can include a tactic selection module 270, and a message displaying module 290 optionally. In an embodiment, the processor 170 executes the computer instructions stored in the memory 110, and after executing the computer instruction, the modules shown in FIG. 2 are generated. In another embodiment, the modules shown in FIG. 2 can be generated by hardware component such as one or more circuit, or a part or entire chip; that is, the processor 170 include hardware components forming the modules of FIG. 2. In other words, the modules in the processor 170 can be software modules or hardware modules, the present invention is not limited to the above-mentioned examples.

The data obtaining module 210 is configured to obtain the wide-open rule. For example, the data obtaining module 210 obtains the inputted wide-open rule provided by the input module 120, obtain the wide-open rule received by the communication interface 130, or obtain the wide-open rule stored in the storage medium 140 in advance. The wide-open rule obtained by the data obtaining module 210 can include all distances between the target offensive player and the defensive players being higher than or equal to a predetermined value, or other offensive player being located between the target offensive player and a certain defensive player who has a distance from the target offensive player lower than the predetermined value when a distance between the target offensive player and the certain defensive player is lower than the predetermined value; however, the present invention is not limited to above-mentioned examples.

The data obtaining module 210 is configured to load the match videos including the historical match videos and the target match video. For example, the data obtaining module 210 loads match videos from the storage medium 140 based on the input storage path inputted by the input module 120 or the data obtaining module 210 is connected to the network device to download the match video through the communication interface 130 based on the input storage path inputted by the input module 120. In an embodiment, the data obtaining module 210 directly loads the match video from a specific folder of the storage medium 140 or downloads the match videos from the specific folder of the network device through the communication interface 130. Each match video loaded by the data obtaining module 210 includes the basketball and the players, and the players in the match video include at least one offensive player and at least one defensive player. In general, different match videos loaded by the data obtaining module 210 can include at least one the same player or include the players of the same team.

The image analyzing module 220 is configured to analyze the match videos loaded by the data obtaining module 210, to extract image features from each of different match video. In the present invention, the image features extracted from the historical match videos by the image analyzing module 220 are called historical image features, the target image features extracted from the target match video are called target image features.

The image analyzing module 220 performs feature extraction on each frame or specific frame of the match videos, to extract image features of the frames of each match videos at different time points. The specific frame can be frames arranged in time interval (such as 0.2 seconds) or number interval (such as 5 frames) in the match videos, or the frame having a similarity degree with the previous frame lower than a certain value, or the frame in which an event occurs such as shooting ball, passing ball, error, blocking or interception; however, the manner of extracting the features of the frames by the image analyzing module 220 is not limited to above-mentioned examples. For example, the image analyzing module 220 can use an object detection model (such as pre-trained YOLO model, or a faster R-CNN model) to detect objects including the players and the ball in the frame, to obtain bounding boxes of objects in the frame, and use pre-trained residual neural network (ResNet) model, visual geometry group (VGG) model or convolution neural network (CNN) model to extract space features in the frame of the match videos, to extract space feature data of the frames and object space feature data of each object in the frames. However, the present invention is not limited to above-mentioned examples. In an embodiment, the image analyzing module 220 can use multiple object tracking (MOT) algorithm such as simple online and realtime tracking (SORT), deep SORT, or Kalman filter, to track the detected object in sequential frames and identify the same object in sequential frame, and arrange the object space feature data of the detected object in each frame based on a sequential order of the frames, to form a temporal sequence data. After the temporal sequence data is formed, the image analyzing module 220 uses recurrent neural networks (RNN) model or long short-term memory (LSTM) model to process temporal sequence data, to generate object time feature data of the detected object in the match video. The object space feature data of the detected object (that is, the basketball or the player) represents a position of the detected object, and the object time feature data of the detected object represents a motion trace and a velocity of the detected object.

The image processing module 230 determines behaviors of the players based on the field positions and the movement traces of the players and the basketball or the image features generated by the image analyzing module 220, and obtains the time when the player starts a determined behavior; in general, the behavior of the offensive player include shooting ball, passing ball, breakthrough, pick, etc., and the behavior of a defensive player includes man coverage, interception, blocking, etc.; however, the present invention is not limited to above-mentioned examples.

The image processing module 230 can identify the behavior of the offensive player represented by the image features through the trained behavior recognition model and/or a pose estimation model based on the image features generated by the image analyzing module 220. For example, the image processing module 230 can use the pose estimation model (such as OpenPose) to determine positions (such as coordinates) of key points on each body part of a player. The body part can include, but not limited to, head, shoulders, elbows, wrists, hips, knees, ankles, etc. The change in the positions of the key points over time can be inputted into the behavior recognition model to identify a behavior of a player; however, the manner of representing the key points and the positions thereof in the present invention is not limited to above-mentioned examples. The image processing module 230 can train the behavior recognition model based on a large number of player images with a known action, for example, the image processing module 230 provides a large number of player images and the known action of the player in each player image into the behavior recognition model, and after the positions of key points of body parts of the player in each player image are determined, the behavior recognition model can be trained based on the positions and the known action of the key points of the body parts in each player image.

The image processing module 230 can determine the behavior of an offensive player based on the field positions and the movement traces of the basketball and the offensive player and a basket position. For example, when the movement trace of the basketball is from the offensive ball-carry player to another offensive player, the image processing module 230 determines that the behavior of the offensive ball-carry player is passing ball; when the movement trace of the basketball is from the offensive ball-carry player to the basket and there is no other offensive player within a certain distance around the basket, the image processing module 230 determines that the behavior of the offensive ball-carry player is shooting; when the movement trace of the basketball is the same as that of the offensive ball-carry player and there is another defensive player within a certain distance around the offensive ball-carry player, the image processing module 230 determines that the offensive ball-carry player is driving; when the movement trace of the basketball is the same as that of the offensive ball-carry player and there is another offensive player not carrying ball within a certain distance around the offensive ball-carry player and there is a defensive player located on side of the offensive player opposite to the offensive ball-carry player, the image processing module 230 determines that the behavior of the offensive player not carrying ball is picking; however, the manner of determining the behavior of the offensive player by the image processing module 230 is not limited to above-mentioned examples.

The image processing module 230 determines the distances and relative positions between the players based on the historical image feature (that is, the object space feature data of the players) generated by the image analyzing module 220, and determines whether the historical image features satisfy the wide-open rule obtained by the data obtaining module 210 based on the distances and relative positions between the players determined by the historical image features.

When determining that the historical image features generated by the image analyzing module 220 satisfy the wide-open rule obtained by the data obtaining module 210, the image processing module 230 also extracts the frame having the historical image features satisfying the wide-open rule from the historical match videos obtained by the data obtaining module 210. In the present invention, the frame extracted from the historical match videos by the image processing module 230 is called a historical match screen, and the position satisfying the wide-open rule in the historical match screen is called a rule wide-open position.

When determining that a certain player passes the basketball to another player based on the field positions of the basketballs and the players represented by the target image features generated by the image analyzing module 220, the image processing module 230 determines a passing direction of the basketball. For example, the image processing module 230 determines the relative positions between the basketball and the players based on the object space feature data of the target image features, and determines the ball-carry player based on the relative positions. The image processing module 230 can also obtain the movement trace of the basketball based on the object time feature data of the target image features and determines the passing direction of the basketball.

When determining that a certain player pass the basketball to another player, the image processing module 230 extracts the frame in which the certain player passes or should pass the basketball to another player, in the target match video. In the present invention, the frame extracted by the image processing module 230 from the target match videos is called a target match screen.

The image processing module 230 obtains a field position of at least one defensive player in each historical match video based on the historical image features generated by the image analyzing module 220 and determines whether the field position of the at least one defensive player satisfies the wide-open rule. The image processing module 230 collects times of the field positions of the defensive player satisfying the wide-open rule based on the field positions of the defensive player, to generate a wide-open distribution times. For example, the image processing module 230 divides the basketball field into M×N blocks, and collects the times of a specific defensive player satisfying the wide-open rule in each block, to generate the wide-open distribution times, and can also collect times of a combination of two or more defensive players satisfying the wide-open rule in each block, to generate the wide-open distribution times, the present invention is not limited to the above-mentioned examples.

When determining that the ball-carry player passes the basketball to the determined rule wide-open position, the image processing module 230 determines whether this passing ball is successful based on the historical image features generated by the image analyzing module 220 and generates a pass success-or-failure status of this passing ball based on the determination result. When determining that the basketball is successful passed to the offensive player at the rule wide-open position based on the object space feature data in the historical image feature, the image processing module 230 generates the pass success-or-failure status representing that this passing ball is successful. When determining that the basketball is not passed to the offensive player at the rule wide-open position successfully based on the object space feature data (for example, the basketball is moved outside the field or moves to the defensive player), the image processing module 230 generates the pass success-or-failure status indicating the failure of passing ball.

The image processing module 230 can identify the defensive player near the rule wide-open position (or at an edge of the rule wide-open position). For example, the image processing module 230 can compare facial features in the historical match video with the prebuilt facial feature of each player to recognize the defensive player, or identify the defensive player based on the bounding boxes determined when tracking the objects in the historical match videos. The present invention is not limited to above-mentioned examples.

The image processing module 230 obtains motion traces and velocities of objects including the basketball and the players in the historical match videos based on the object time feature data in the historical image features, and calculates the movement trace of the basketball and the field positions of the players in the historical match videos at different time points, based on the obtained motion traces and the velocities of the basketball and the players.

The model training module 250 uses a machine learning algorithm to train the wide-open analysis model based on the historical image features generated by the image analyzing module 220 and the rule wide-open positions generated by the image processing module 230. The machine learning algorithm is a reinforcement learning (RL) model, but the present invention is not limited to above-mentioned examples.

In an embodiment, to improve the accuracy of the wide-open analysis model in determining the wide-open position, when the model training module 250 trains the wide-open analysis model, in addition to using the historical image feature and the rule wide-open position, the model training module 250 also uses the pass success-or-failure status generated by the image processing module 230 and the limb parameters of the defensive player on the edge of the rule wide-open position to train the wide-open analysis model.

The model training module 250 can train the action prediction model based on the object time feature data of the basketball and the players in the historical image features generated by the image analyzing module 220 trained by the model training module 250, that is, the model training module 250 can train the action prediction model based on the motion traces of the basketball and each player in each historical match video at different time points and the field positions of each player at each time in the same historical match video; however, the data for training the action prediction model in the present invention are not limited to the above examples.

The wide-open identification module 260 can use the wide-open analysis model trained by the model training module 250 to analyze the target image feature extracted by the image processing module 230 from the target match screen (that is, the image analyzing module 220 analyzes the target image features generated from the target match screen of the target match video) to obtain the wide-open position in the target match screen. It is to be noted that the wide-open identification module 260 can analyze one or more wide-open positions in the target match screen.

The wide-open identification module 260 predicts the position of each player at a specific time in a future period based on the action prediction model trained by using the field positions of the basketball and the players in the target match video by the model training module 250. In the present invention, the position of the player in a future specific time is called a predicted position. The wide-open identification module 260 uses the wide-open analysis model to analyze a predicted wide-open position at the specific time based on the predicted positions of the players.

The tactic selection module 270 selects an offensive tactic based on the field position of the at least one defensive player represented by the target image features generated by the image analyzing module 220 and the wide-open distribution times generated by the image processing module 230. For example, the tactic selection module 270 selects the offensive tactic for attacking the wide-open pass position having the highest wide-open distribution times corresponding to the field positions of the defensive players. In an embodiment, when there are multiple offensive tactics, the tactic selection module 270 selects the offensive tactic having highest scoring rate among the multiple offensive tactics.

When the suggestion generating module 280 determines that the passing direction determined by the image processing module 230 does not match the wide-open position generated by the wide-open identification module 260, the suggestion generating module 280 generates the passing suggestion. The passing suggestion generated by the suggestion generating module 280 includes a time point of passing ball and a track of passing ball. For example, the passing suggestion can be a suggestion for the ball-carry player to pass the basketball to one of the wide-open positions when the ball-carry player wants to pass ball, or a suggestion for the ball-carry player to pass the basketball to one of the wide-open positions before or after the ball-carry player wants to pass ball. For example, the suggestion generating module 280 can select the widest wide-open position to generate the passing suggestion, but the present invention is not limited to above-mentioned examples.

The suggestion generating module 280 can generate the passing suggestion based on the offensive tactic generated by the tactic selection module 270. For example, the suggestion generating module 280 generates the passing suggestion of passing the basketball to the wide-open position having the highest wide-open distribution times, so that the position to which the basketball is passed can match the offensive tactic.

The message displaying module 290 can provide a video signal of the target match video loaded by the data obtaining module 210 to the output module 150, so that the output module 150 can display the target match video on the displayer of the device 100.

When providing the target match video to the output module 150 for display, the message displaying module 290 can add the passing suggestion generated by the suggestion generating module 280 into the video signal of the target match video provided to the output module 150, and add a mark of the wide-open position generated by the wide-open identification module 260 using the wide-open analysis model to analyze the target match video in the video signal of the target match video.

In an embodiment, when providing the video signal of the target match video to the output module 150 for display, the message displaying module 290 can add a display area of a tactical board in the video signal of the target match video. On the tactical board, the field positions of the players determined by the image processing module 230, and the wide-open position determined by the wide-open identification module 260, and the passing suggestion generated by the suggestion generating module 280 are marked. For example, the displayed passing suggestion can be all content of the passing suggestion or a part (such as the track of passing ball) of the passing suggestion.

When the target match video includes synchronous match videos with different viewing angles, the message displaying module 290 can select one of viewing angles through the input module 120, so that the match video corresponding to the selected viewing angle can be displayed.

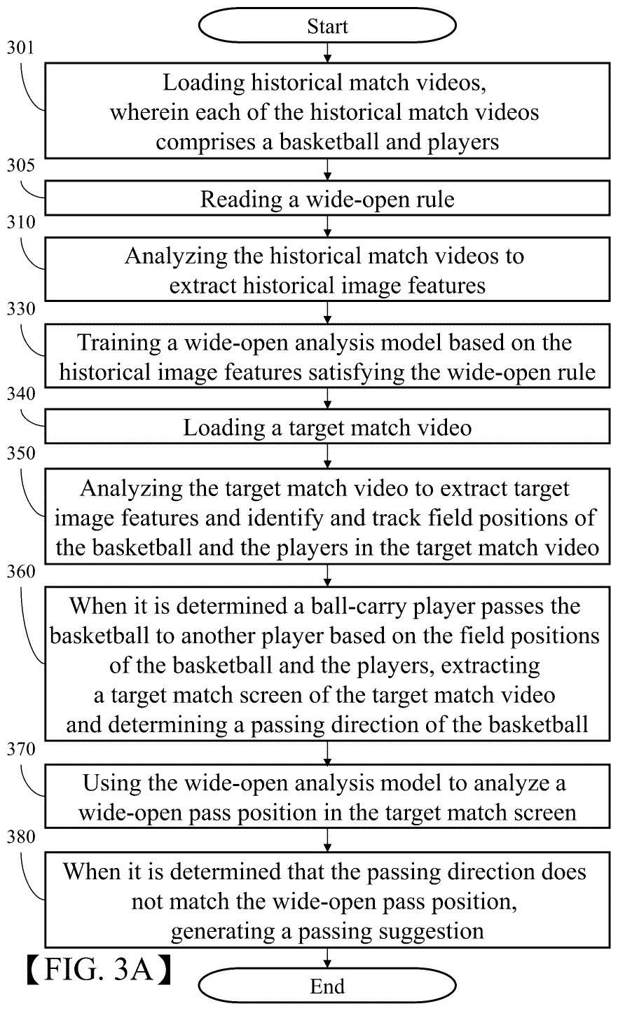

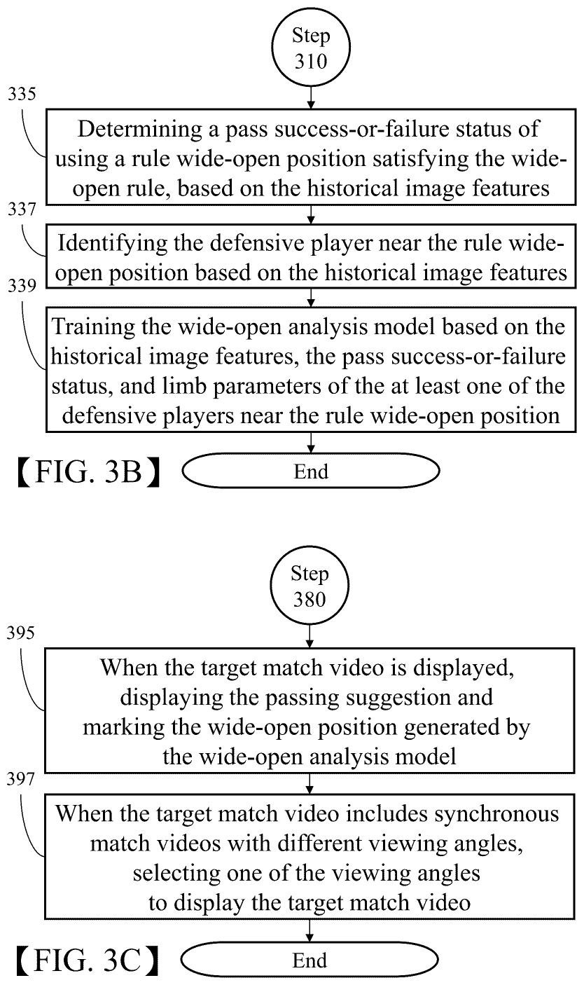

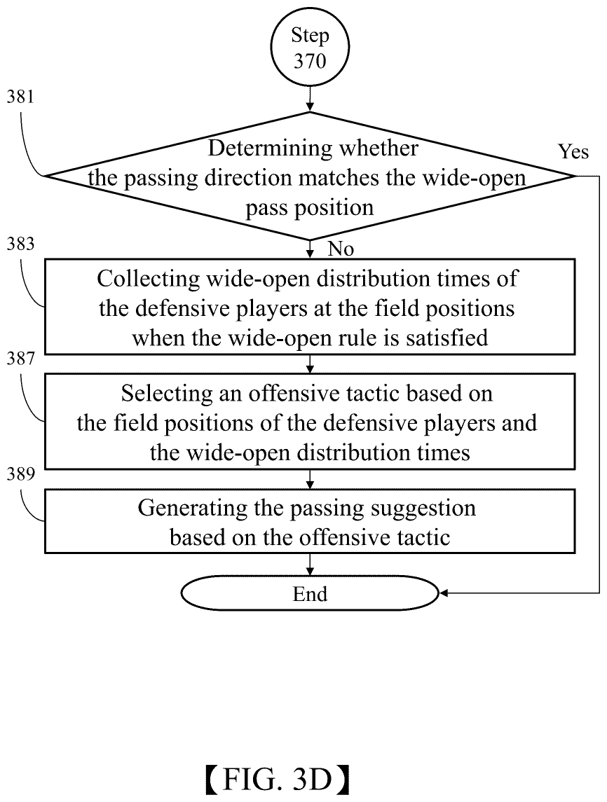

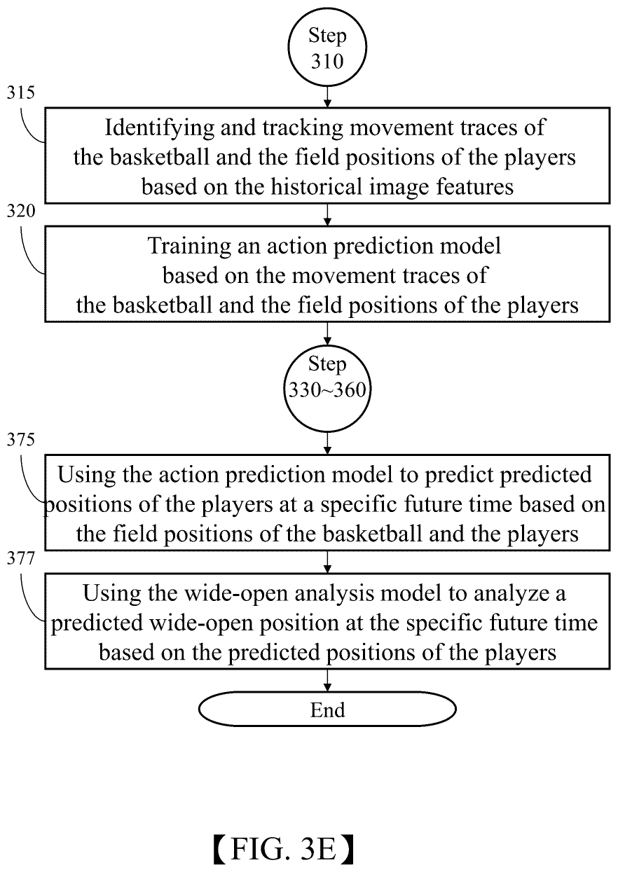

The operation of the system and the method of the present invention will be illustrated with reference to an embodiment. Please refer to FIG. 3A, which is a flowchart of a method of finding a wide-open pass position to provide an offensive passing suggestion, according to the present invention. In this embodiment, the device 100 can be a computer or a server including multiple top-level processing cores.

When team personnel such as a basketball coach, an assistant or a player wants to improve the ball passing level of a player (especially a point guard) by reviewing a match content, the present invention can be used to train the wide-open analysis model.

First, in a step 301, the team personnel uses the personal computer to connect to the device 100, and inputs storage paths and file names of the historical match videos into the user interface provided by the data obtaining module 210 of the device 100 through the personal computer, the inputted storage paths and file names of the historical match video are transmitted back to the device 100, to make the device 100 load the historical match video. In an embodiment, when the historical match video are stored in an external file server, after the processor 170 of the device 100 executes the computer instructions stored in the memory 110 of the device 100, the executable modules shown in FIG. 2 can be generated, so that the data obtaining module 210 of the device 100 can be connected to the external file server through the communication interface 130 of the device 100, to download historical match videos from the file server based on the storage paths and the file names of the historical match videos received by the communication interface 130.

In a step 305, when the data obtaining module 210 of the device 100 loads the historical match videos (the step 301), the data obtaining module 210 can read the wide-open rule. In this embodiment, in a condition that the data obtaining module 210 readout the prebuilt wide-open rule from the storage medium 140 of the device 100. It is to be noted that, in the present invention, the steps of loading the historical match video (the step 301) and reading the wide-open rule (the step 305) by the data obtaining module 210 do not have a sequence relationship; in other words, the data obtaining module 210 can read the wide-open rule (the step 305) first, and then load the historical match video (the step 301).

In a step 310, after the data obtaining module 210 of the device 100 loads the historical match videos (the step 301), the image analyzing module 220 of the device 100 analyzes the loaded historical match videos to extract the historical image feature of each historical match video at different time points.

In a step 330, the image processing module 230 of the device 100 determines whether the distances and relative positions between the players represented by historical image feature generated by the image analyzing module 220 satisfy the wide-open rule, the model training module 250 of the device 100 uses the machine learning algorithm to train the wide-open analysis model based on the historical image features determined to satisfy the wide-open rule by the image processing module 230. In this embodiment, in a condition that the image processing module 230 can obtain the distances and relative positions between the players based on the each of the historical image features, and determine whether the distances between an offensive player and the defensive players are higher than or equal to a predetermined value, and if yes, it indicates that there is a rule wide-open position corresponding to the offensive player; otherwise, the image processing module 230 continuously determines whether other offensive player is located between the offensive player and the defensive player having a distance lower than the predetermined value therebetween, if yes, it indicates that there is a rule wide-open position corresponding to the offensive player; otherwise, it indicates that there is no rule wide-open position corresponding to the offensive player. When the distance and the relative position between the players represented by one of historical image features satisfy the wide-open rule, the image processing module 230 records the one of the historical image features satisfying the wide-open rule, and continuously determines whether other historical image feature satisfy the wide-open rule until all historical image features are checked. Next, the model training module 250 trains the wide-open analysis model based on the historical image features recorded by the image processing module 230, to complete training of the wide-open analysis model.

In addition, in a step 335, to increase accuracy of the wide-open analysis module analyzing the wide-open position, the image processing module 230 of the device 100 determines a pass success-or-failure status of the rule wide-open position satisfying the wide-open rule based on the historical image features generated by the image analyzing module 220 of the device 100, as shown in FIG. 3B. In a step 337, the image processing module 230 can identify the defensive player at edge of the determined rule wide-open position based on the historical image features. In a step 339, the model training module 250 of the device 100 can use the historical image features generated by the image analyzing module 220, the pass success-or-failure status of the rule wide-open position determined by the image processing module 230, and limb parameters of the defensive player at edge of the rule wide-open position obtained by the data obtaining module 210 of the device 100, to train the wide-open analysis model.

In the process of FIG. 3A, after the model training module 250 of the device 100 completes the training of the wide-open analysis model, the device 100 provides the team personnel to watch a target match video to review a match content. As a result, in a step 340, the data obtaining module 210 of the device 100 can load the target match video. In this embodiment, similar to the data obtaining module 210 of the device 100 loading the historical match videos (the step 301), the team personnel can use the personal computer to connect the device 100, and input the storage paths and file names of the target match videos into the user interface provided by the data obtaining module 210 of the device 100 through the personal computer, the inputted storage paths and file names of the target match videos are transmitted back to the device 100, so that the data obtaining module 210 of the device 100 can be connected to the external file server through the communication interface 130 of the device 100, to download the target match video from the file server based on the storage path and the file name of the target match video received by the communication interface 130.

In a step 350, after the data obtaining module 210 of the device 100 loads the target match video, the image analyzing module 220 of the device 100 analyzes the loaded historical match videos to extract the target image features of each historical match video at different time points, and identify and track the field positions of the basketball and the players in the target match video during the process of extracting the target image features. In this embodiment, in a condition that the image analyzing module 220 uses a multiple object track algorithm to identify the field positions of the basketball and the players in the target match video at different time points (such as different frames) and extract the target image features of the target match video at different time points based on the changes in the field positions of the basketball and the players in the target match video.

After the image analyzing module 220 of the device 100 extracts the target image features of the target match video and identifies and tracks the field positions of the basketball and the players in the target match video (the step 350), when the image processing module 230 of the device 100 determines that the ball-carry player passes the basketball to other player based on the field positions of the basketball and the player obtained by the image analyzing module 220, the image processing module 230 extracts the target match screen of the target match video in which the ball-carry player pass the basketball and determines the passing direction in which the ball-carry player passes the basketball, in a step 360.

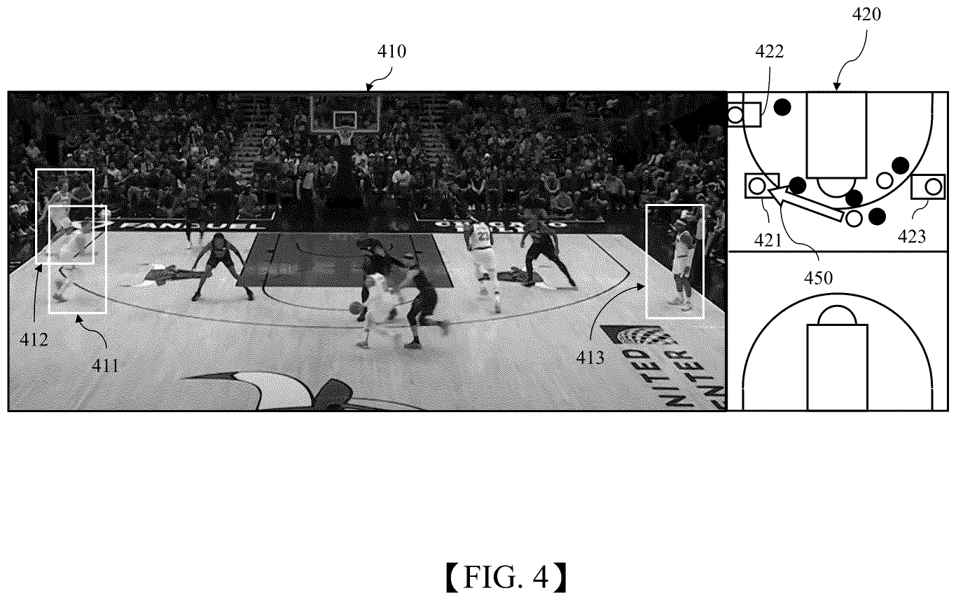

Similarly, after the image analyzing module 220 of the device 100 extracts the target image features of the target match video and identifies and tracks the field positions of the basketball and the players in the target match video (the step 350), the wide-open identification module 260 of the device 100 uses the wide-open analysis model trained by the model training module 250 of the device 100 to analyze the wide-open position in the target match video, in a step 370. In this embodiment, in a condition that the image analyzing module 220 of the device 100 extracts five frames of the target match video per second to perform image analysis, that is, the image analyzing module 220 generate a set of target image features for the target match video per 0.2 seconds, the wide-open identification module 260 uses the wide-open analysis model to analyze each set of target image features to identify the wide-open position in the target match video per 0.2 seconds. The identified wide-open positions include the wide-open pass position (411˜413) where the ball-carry player pass the basketball, as shown in FIG. 4.

After the wide-open identification module 260 of the device 100 uses the wide-open analysis model to analyze the wide-open position in the target match video (the step 370), in a step 380, the suggestion generating module 280 of the device 100 can generate a passing suggestion when determining that the passing direction generated by the image processing module 230 of the device 100 does not match the wide-open position analyzed by the wide-open identification module 260. In this embodiment, in a condition that the passing direction and the wide-open position of ball-carry player do not match with each other, the suggestion generating module 280 selects the wide-open position to generate the passing suggestion when the ball-carry player is passing ball, or select the best wide-open position before the ball-carry player passes ball, to generate the passing suggestion 450, as shown in FIG. 4.

The present invention can determine whether the ball-carry player selects the best timing to pass the basketball to the best position when the ball-carry player passes the basketball, so that the ball-carry player can get feedback after actual match.

As shown in FIG. 3C, in above-mentioned embodiment, in a condition that the processor 170 of the device 100 can generate the message displaying module 290, after the suggestion generating module 280 of the device 100 generates the passing suggestion (the step 380), when the message displaying module 290 generates the video signal of the target match video loaded by the data obtaining module 210 of the device 100 and provides the video signal to the output module 150 of the device 100 to display on the displayer of the device 100 or the message displaying module 290 provides the video signal to the communication interface 130 of the device 100 and the communication interface 130 transmits the video signal to the external displayer for display, the message displaying module 290 can add an area of the tactical board into the generated video signal, and display the passing suggestion on the video signal of the target match video and the tactical board, and mark the wide-open position generated by the wide-open identification module 260 of the device 100, so that the target match video displayed on the displayer by the output module 150 or the target match video transmitted to and displayed on the external displayer through the communication interface 130 by the output module 150 can include the match screen 410, the tactical board 420, and the wide-open position (411˜413) on the match screen 410, the wide-open position 421˜423 corresponding to the wide-open position 411˜413 on the tactical board 420, and the passing suggestion 450, in a step 395. In a step 397, when the target match video loaded by the data obtaining module 210 includes synchronous match videos with different viewing angles, the input module 120 of the device 100 can provide team personnel to select one of viewing angles, so that the message displaying module 290 can generate a video signal of the target match video corresponding to the selected viewing angle, the output module 150 can display the target match video corresponding to the selected viewing angle on the displayer.

As shown in FIG. 3D, in above-mentioned embodiment, in a condition that the processor 170 of the device 100 can generate the tactic selection module 270, when the suggestion generating module 280 determines that the passing direction does not match the wide-open position (the step 381), in a step 383, the tactic selection module 270 collects the wide-open distribution times when the defensive player represented by the historical image features at the field position satisfying the wide-open rule; in a step 387, the tactic selection module 270 selects an offensive tactic based on the field positions of the defensive player represented by the target image features and the wide-open distribution times; in a step 389, the suggestion generating module 280 generates the passing suggestion based on the offensive tactic selected by the tactic selection module 270.

In addition, as shown in FIG. 3E, in above-mentioned embodiment, during the process that the image analyzing module 220 of the device 100 analyzes the historical match video to generate the historical image features, the image analyzing module 220 can identify and track the movement trace of the basketball and the field positions of the players in each historical match video (the steps 310 and 315), the model training module 250 of the device 100 trains the action prediction model based on the movement trace of the basketball and the field positions of the players analyzed by the image analyzing module 220 (step 320); next, the wide-open identification module 260 of the device 100 can use the action prediction model to predict the predicted positions of the players in a future specific time based on the field positions of the basketball and the players in the target match video, in a step 375; next, the wide-open identification module 260 can use the wide-open analysis model to analyze the predicted wide-open position at the specific time based on the predicted position of the players, in a step 377.

According to above-mentioned contents, the difference between the present invention and the conventional technology is that, in the present invention, the historical match videos are used to train the wide-open analysis model, the trained wide-open analysis model is used to determine the wide-open positions in the target match video, and the passing direction of the ball-carry player in the target match video is determined; when it is determined that the passing direction does not match the wide-open position, the passing suggestion is generated to provide the players with opportunities to fully understand and apply tactics. Therefore, the above-mentioned solution can solve the conventional problem that it is difficult to provide a player with an opportunity to fully understand and apply tactics except in actual match, and achieve the effect of providing a teaching model that provides experience of the competition process and feedback.

Furthermore, the method of finding a wide-open pass position to provide offensive passing suggestion according to the present invention can be implemented by hardware, software or a combination thereof, and can be implemented in a computer system by a centralization manner, or by a distribution manner of different components distributed in several interconnect computer systems.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A method of finding a wide-open pass position to provide an offensive passing suggestion, wherein the method is applicable to a device and comprises:
loading one or more historical match videos, wherein each of the historical match videos comprises a basketball and players, and the players comprises at least one offensive player and at least one defensive player;
reading a wide-open rule;
analyzing the historical match videos to extract historical image features of each of the historical match videos at different time points;
using a machine learning algorithm to train a wide-open analysis model based on the historical image features which represent distances and relative positions between the players satisfying the wide-open rule;
loading a target match video, wherein the target match video includes at least one of the players;
analyzing the target match video to extract one or more target image features of the target match video at different time points, and to identify and track one or more field positions of the basketball and the players in the target match video;
when it is determined that a ball-carry player among the players passes the basketball to another player among the players based on the field positions of the basketball and the players, extracting a target match screen of the target match video in which the basketball is passed, and determining a passing direction of the basketball;
using the wide-open analysis model to analyze at least one wide-open pass position in the target match screen; and
when it is determined that the passing direction does not match the at least one wide-open pass position, generating a passing suggestion.

2. The method of finding a wide-open pass position to provide an offensive passing suggestion according to claim 1, after the step of determining that the passing direction does not match the wide-open pass position, further comprising:
collecting wide-open distribution times of at least one of the defensive players at the field positions represented by the historical image features when the wide-open rule is satisfied, and selecting an offensive tactic based on the field positions of the at least one of the defensive players represented by the target image feature and the wide-open distribution times, and generating the passing suggestion based on the offensive tactic.

3. The method of finding a wide-open pass position to provide an offensive passing suggestion according to claim 1, wherein the step of using the machine learning algorithm to train the wide-open analysis model based on the historical image features representing the distances and the relative positions between the players satisfying the wide-open rule comprises:
determining a pass success-or-failure status of a rule wide-open position satisfying the wide-open rule and identifying at least one of the defensive players near the rule wide-open position based on the historical image features, and using the machine learning algorithm to train the wide-open analysis model based on the historical image features, the pass success-or-failure status, and one or more limb parameters of the at least one of the defensive players near the rule wide-open position, wherein a limb parameter comprises at least one of a height, an arm length, a leg length and a pace distance.

4. The method of finding a wide-open pass position to provide an offensive passing suggestion according to claim 1, after the step of generating the passing suggestion, further comprising:
when the target match video is displayed, displaying the passing suggestion and marking the wide-open position generated by using the wide-open analysis model to analyze the target match videos.

5. The method of finding a wide-open pass position to provide an offensive passing suggestion according to claim 1, after the step of loading a target match video, further comprising:
when the target match video comprises synchronous match videos with different viewing angles, selecting one of the different viewing angles to display the target match video.

6. The method of finding a wide-open pass position to provide an offensive passing suggestion according to claim 1, after the step of extracting the historical image features of each of the historical match videos at different time points, further comprising:
training an action prediction model based on movement traces of the basketball and the field positions of the players in each of the historical match videos, and
wherein the step of using the wide-open analysis model to analyze the at least one wide-open pass position of the target match screen, further comprises:
using the action prediction model to predict predicted positions of the players at a specific future time based on the field positions of the basketball and the players in the target match video; and
using the wide-open analysis model to analyze a predicted wide-open position at the specific future time based on the predicted positions of the players.

7. A system of finding a wide-open pass position to provide an offensive passing suggestion, wherein the system is applicable to a device and comprises:
a memory, configured to store at least one computer instruction; and
a processor, connected to the memory and configured to execute the at least one computer instruction to make the system execute:
loading one or more historical match videos, wherein each of the historical match videos comprises a basketball and players, and the players comprises at least one offensive player and at least one defensive player;
reading a wide-open rule;
analyzing the historical match videos to extract one or more historical image features of each of the historical match videos at one or more different time points;
using a machine learning algorithm to train a wide-open analysis model based on the historical image features representing distances and relative positions between the players satisfying the wide-open rule;
loading a target match video, wherein the target match video includes at least one of the players;
analyzing the target match video to extract target image features of the target match video at different time points, and to identify and track the field positions of the basketball and the players in the target match video;
when it is determined that a ball-carry player among the players passes the basketball to another player among the players based on the field positions of the basketball and the players, extracting a target match screen of the target match video in which the basketball is passed, and determining a passing direction of the basketball;
using the wide-open analysis model to analyze at least one wide-open pass position in the target match screen; and
when it is determined that the passing direction does not match the at least one wide-open pass position, generating a passing suggestion.

8. The system of finding a wide-open pass position to provide an offensive passing suggestion according to claim 7, wherein the system further executes:
collecting wide-open distribution times of at least one of the defensive players at the field positions represented by the historical image features when the wide-open rule is satisfied, and selecting an offensive tactic based on the field positions of the at least one of the defensive players represented by the target image feature and the wide-open distribution times, and generating the passing suggestion based on the offensive tactic.

9. The system of finding a wide-open pass position to provide an offensive passing suggestion according to claim 7, wherein the system further execute:
determining a pass success-or-failure status of a rule wide-open position satisfying the wide-open rule and identifying at least one of the defensive players near the rule wide-open position based on the historical image features, and using the machine learning algorithm to train the wide-open analysis model based on the historical image features, the pass success-or-failure status, and one or more limb parameters of the at least one of the defensive players near the rule wide-open position, wherein a limb parameter comprises at least one of a height, an arm length, a leg length and a pace distance.

10. The system of finding a wide-open pass position to provide an offensive passing suggestion according to claim 7, wherein the system further executes:
when the target match video is displayed, displaying the passing suggestion and marking the wide-open position generated by using the wide-open analysis model to analyze the target match videos.

11. The system of finding a wide-open pass position to provide an offensive passing suggestion according to claim 7, wherein the system further executes:
when the target match video comprises synchronous match videos with different viewing angles, selecting one of the different viewing angles to display the target match video.

12. The system of finding a wide-open pass position to provide an offensive passing suggestion according to claim 7, wherein the system further executes:
identifying and tracking movement traces of the basketball and the field positions of the players in each of the historical match videos, and training an action prediction model based on the movement traces of the basketball and the field positions of the players, and using the action prediction model to predict predicted positions of the players at a specific future time based on the field positions of the basketball and the players in the target match video, and using the wide-open analysis model to analyze a predicted wide-open position at the specific future time based on the predicted positions of the players.
